(19) United States
(12) Patent Application Publication
(10) Pub. No.: US 2006/0292479 A1
(43) Pub. Date: Dec. 28, 2006

(54) System and method for applying spacer elements

(76) Inventor: Philip S. Burkum, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/159,457

(22) Filed: Jun. 23, 2005

(51) Int. Cl. G03G 15/10; G03G 15/14

(52) U.S. Cl. 430/117; 430/20

(57) ABSTRACT

A method comprising transferring first liquid toner having one or more spacer elements to a first discharged portion of the photoconductor drum to form a first image on the photoconductor drum and transferring the first image to a substrate is provided.

### BACKGROUND

Liquid crystal display (LCD) devices may be found in many electric devices. LCD devices include a screen with pixels that are configured to transmit or not transmit light according to an image input to form an image. Among other factors, the resolution of the image depends on the size of the pixels. Generally speaking, smaller pixels may be used to generate an image with a higher resolution than larger pixels. Accordingly, it is often desirable to produce LCD devices with as small of a pixel size as possible.

LCD devices typically include liquid crystal material contained between a pair of display panels. One of the display panels often includes the electronics to cause the liquid crystal material to transmit or not transmit light for each pixel, and the other display panel often includes a color filter to allow color to be produced by a pixel when it transmits light. The color filter may include optical layers such as a black matrix layer, one or more color filter layers, a planarization layer, and a dielectric layer. Generally, structural features are included between the display panels to provide a precise liquid crystal layer thickness for effective light shuttering and predictable optical response. The placement, composition, and/or manufacturing of the structural features may inhibit the performance or add to the cost of an LCD device.

### SUMMARY

One form of the present invention provides a method comprising transferring first liquid toner having one or more spacer elements to a first discharged portion of the photoconductor drum to form a first image on the photoconductor drum and transferring the first image to a substrate.

### BRIEF DESCRIPTION OF THE DRAWINGS

FIG. 1 is a schematic diagram illustrating a system for generating and transferring layers to a substrate using a liquid electrophotography process according to one embodiment of the present invention.

FIG. 2A is a schematic diagram illustrating an impression mechanism according to one embodiment of the present invention.

FIG. 2B is a schematic diagram illustrating an impression mechanism according to one embodiment of the present invention.

FIG. 3 is a flow chart illustrating a method for generating and transferring layers to a substrate using a liquid electrophotography process according to one embodiment of the present invention.

FIG. 4 is a flow chart illustrating a method for generating and transferring layers to a substrate with a blanket using a liquid electrophotography process according to one embodiment of the present invention.

FIG. 5 is a flow chart illustrating a method for generating and transferring layers of a display panel to a substrate using a liquid electrophotography process according to one embodiment of the present invention.

FIG. 6 is a schematic diagram illustrating layers transferred to a blanket as part of a liquid electrophotography process according to one embodiment of the present invention.

FIGS. 7A and 7B are schematic diagrams illustrating layers transferred to a display panel using a liquid electrophotography process according to one embodiment of the present invention.

FIG. 8 is a schematic diagram illustrating a cross-section of a portion of a liquid crystal display (LCD) device according to one embodiment of the present invention.

### DETAILED DESCRIPTION

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

As described herein, a system and method for applying spacer elements to a substrate using a liquid electrophotography (LEP) process is provided. The spacer elements and a liquid toner are applied to the substrate as a spacer layer. The spacer layer is generated on a photoconductor drum and transferred to an intermediate transfer medium such as a blanket. The spacer layer is transferred from an intermediate transfer medium to the substrate. In one embodiment, the substrate comprises a front or rear panel of a liquid crystal display (LCD).

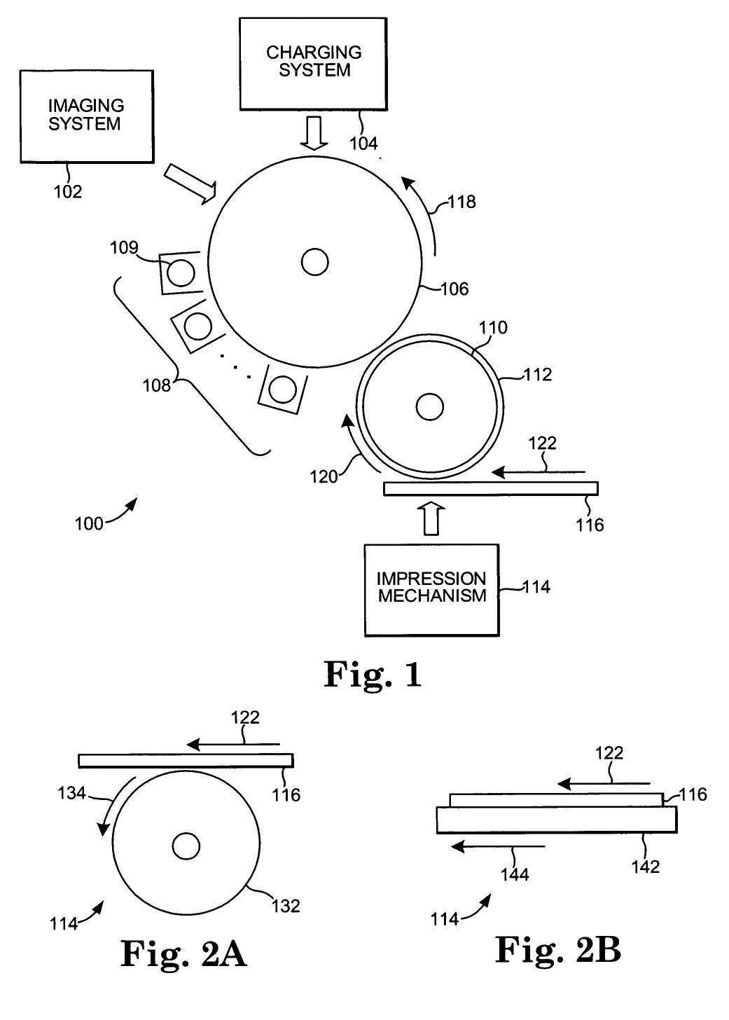

FIG. 1 is a schematic diagram illustrating a system 100 for applying spacer elements to a substrate 116 using a liquid electrophotography (LEP) process. System 100 may also be used to apply other layers to substrate 116 as described herein. System 100 includes an imaging system 102, a charging system 104, a cylindrical photoconductor drum 106, a plurality of liquid toner cartridges 108, a cylindrical intermediate transfer member 110 that includes a blanket 112, and an impression mechanism 114.

Imaging system 102 is a laser imager configured to create a latent image on photoconductor drum 106. Charging system 104 includes a scorotron assembly (not shown) that includes one or more scorotron units (not shown). The scorotron units are configured to negatively charge photoconductor drum 106 as photoconductor drum 106 is rotated past charging system 104 as indicated by an arrow 118. Image system 102 includes at least one writing head configured to project a laser beam onto selected areas of photoconductor drum 106 to discharge the selected areas as photoconductor drum 106 is rotated past imaging system 102. The discharged areas of photoconductor drum 106 comprise the latent image.

Each of the liquid toner cartridges 108 includes a developer 109 and liquid toner of a selected type, e.g., transparent, black matrix, color filter, planarization, or dielectric, and color, e.g., red, green, blue, or black. The liquid toner comprises particles that have been milled into a pigmented plastic and dissolved into lsopar™, i.e., an Isoparaffinic solvent available from ExxonMobil Chemical Company, 13501 Katy Freeway, Houston, Tex. 77079 USA, along with a charge director.

At least one liquid toner cartridge 108 includes liquid toner and spacer elements (hereafter referred to as spacer liquid toner cartridge 108). The spacer elements comprise any suitable shape or set of shapes and material or set of materials that are configured to provide a structural space between a substrate and another structural member (e.g., between a front panel and a rear panel of an LCD device). In one embodiment, the spacer elements comprise milled glass spheres that are approximately 5 microns in diameter. In other embodiments, the spacer elements comprise other hard, precise-diameter materials that have been milled or created by another suitable process. A charge-director chemical is applied to the liquid toner and the spacer elements to cause the liquid toner and the spacer elements to respond to electric fields and close proximity charge sites. The spacer element density in spacer liquid toner cartridge 108 may be controlled by adjusting the spacer element to liquid toner ratio, the concentration of the liquid toner before or during development, and/or the number of spacer layers applied to the substrate.

In one embodiment, the liquid toner in spacer liquid toner cartridge 108 comprises a transparent liquid toner. In another embodiment, the liquid toner in spacer liquid toner cartridge 108 comprises a black liquid toner for use in creating a black matrix layer.

In one embodiment, one liquid toner cartridge 108 includes a black pigment that is used to create a black matrix layer. Three liquid toner cartridges 108 include red, green, and blue pigments, respectively, that are used to create color filter layers. One liquid toner cartridge 108 includes a transparent material that is used to create a planarization layer, and one liquid toner cartridge 108 includes a dielectric material that is used to create a dielectric layer. In other embodiments, system 100 includes other types or numbers of liquid toner cartridges 108.

In response to being activated, a liquid toner cartridge 108 develops the liquid toner using developer 109. As the discharged areas of photoconductor drum 106 pass over an activated liquid toner cartridge 108, liquid toner transfers from developer 109 in activated liquid toner cartridge 108 to the discharged areas of photoconductor drum 106 to create an image. When the spacer liquid toner cartridge 108 is activated, spacer elements along with liquid toner transfer from developer 109 in activated liquid toner cartridge 108 to the discharged areas of photoconductor drum 106 to create an image. In one embodiment, the image for the spacer layer aligns with a black matrix layer to allow the spacer elements to be applied along the black matrix layer.

The image is transferred electrostatically from photoconductor drum 106 to blanket 112 as photoconductor drum 106 rotates past intermediate transfer member 110. Intermediate transfer member 110 rotates in the direction indicated by arrow 120. In one embodiment, blanket 112 comprises a multi-layer fabric-reinforced foam rubber configured to electrostatically transfer the liquid toner from photoconductor drum 106 to intermediate transfer member 110. In other embodiments, blanket 112 comprises another type of material. Intermediate transfer member 110 heats the image on blanket 112 to cause the Isopar in the image to evaporate. Blanket 112 also absorbs some of the Isopar in the image to increase the solid content of the image.

A discharge system (not shown) such as a light emitting diode (LED) erase lamp removes residual charge from photoconductor drum 106 prior to the image being transferred to blanket 112. After the image is transferred to blanket 112, a cleaning system (not shown) cleans photoconductor drum 106 to remove any remaining toner.

System 100 repeats the above process to create any number of additional layers of images on blanket 112. The additional layers may be the same type and/or color, i.e. use liquid toner from the same liquid toner cartridge 108, or may be a different type and/or color, i.e. use liquid toner from a different liquid toner cartridge 108 as any previous layers. Thus, any number of spacer layers that include spacer elements may be created in images on blanket 112.

After all of the desired layers have been created on blanket 112, the combined image is transferred from blanket 112 to substrate 116 using impression mechanism 114. Impression mechanism 114 drives substrate 116 along intermediate transfer member 110 in the direction indicated by an arrow 122 and applies pressure to substrate 116 to cause the combined image, i.e. all layers created on blanket 112, to be transferred to substrate 116.

In embodiments where substrate 116 comprises a front or rear panel of an LCD device, the combination of substrate 116 and the layers transferred to substrate 116 are referred to herein as display panel 116. Substrate 116 comprises any material suitable for use as a display panel for a LCD device such as glass or clear plastic in such embodiments.

FIG. 2A is a schematic diagram illustrating an embodiment of impression mechanism 114. In FIG. 2A, impression mechanism 114 comprises an impression cylinder 132 that rotates in the direction indicated by an arrow 134 to drive substrate 116 between intermediate transfer member 110 (shown in FIG. 1) and impression cylinder 132 in the direction indicated by arrow 122. As substrate 116 passes between intermediate transfer member 110 and impression cylinder 132, impression cylinder 132 also applies pressure between substrate 116 and intermediate transfer member 110 to cause the combined image, i.e. all layers created on blanket 112, to be transferred to substrate 116.

FIG. 2B is a schematic diagram illustrating another embodiment of impression mechanism 114. In FIG. 2B, impression mechanism 114 comprises a platen 142 that is driven in the direction indicated by an arrow 144 to drive substrate 116 between intermediate transfer member 110 (shown in FIG. 1) and platen 142 in the direction indicated by arrow 122. As substrate 116 passes between intermediate transfer member 110 and platen 142, platen 142 also applies pressure between substrate 116 and intermediate transfer member 110 to cause the combined image, i.e. all layers created on blanket 112, to be transferred to substrate 116.

In the spacer layer, the application of heat and pressure from intermediate transfer mechanism 110 and/or impression mechanism 114 may allow the liquid toner of the spacer layer to flow. During such a process, the spacer elements in the spacer layer migrate into a plane, and the liquid toner migrates out of high pressure zones between the spacer elements and substrate 116. As a result, the thickness of the spacer layer may be set to be approximately the diameter of the spacer elements.

In other embodiments, photoconductor drum 106 includes a permanent pattern that comprises the latent image. In such embodiments imaging system 102 may be omitted.

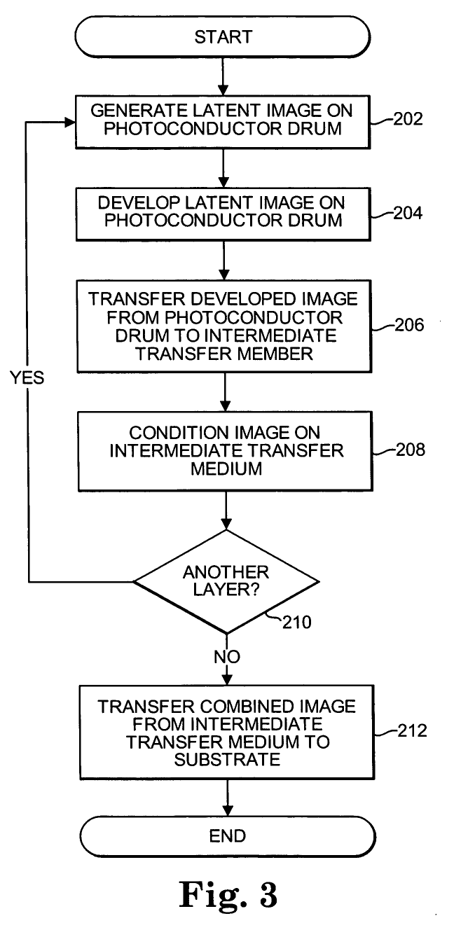

FIG. 3 is a flow chart illustrating a method for generating and transferring layers, including one or more spacer layers, to a substrate using a liquid electrophotography process. The method of FIG. 3 will be described with reference to system 100.

In FIG. 3, a latent image is generated on photoconductor drum 106 as indicated in a block 202. In system 100, imaging system 102 discharges selected areas of photoconductor drum 106 that have been negatively charged by charging system 104 to generate the latent image. The latent image is developed on photoconductor drum 106 as indicated in a block 204. An activated liquid toner cartridge 108 applies liquid toner to the discharged areas of photoconductor drum 106 to develop the latent image. For the spacer layer, spacer liquid toner cartridge 108 is activated to apply liquid toner and spacer elements to the discharged areas of photoconductor drum 106 to develop the latent image.

The developed image is transferred from photoconductor drum 106 to intermediate transfer member 110 as indicated in a block 206. To transfer the developed image from photoconductor drum 106 to intermediate transfer member 110, an electrical bias is applied to blanket 112 to cause the charged liquid toner that comprises the developed image to transfer to blanket 112 on intermediate transfer member 110.

The image is conditioned on intermediate transfer member 110 as indicated in a block 208. Intermediate transfer member 110 heats blanket 112 to cause the Isopar in the liquid toner to evaporate and the plastic-coated particles in the liquid toner to form a film to condition the image. By evaporating the Isopar, the liquid toner solidifies on blanket 112.

A determination is made as to whether there is another layer to generate as indicated in a block 210. If there is another layer to generate, then the process of blocks 202 through 208 is repeated for the next layer. The next layer may be generated using liquid toner from the same or a different liquid toner cartridge 108 as the previous layer.

If there is not another layer to generate, then the combined image, i.e. the images from each layer generated in the process of blocks 202 through 210, is transferred from intermediate transfer member 110 to substrate 116 as indicated in a block 212. Impression mechanism 114 drives substrate 116 between intermediate transfer member 110 and impression mechanism 114 and applies pressure between substrate 116 and intermediate transfer member 110 to cause the combined image to be transferred to substrate 116.

In one embodiment of the method of FIG. 3, the optical layers generated and transferred to substrate 116 include a black matrix layer, a color filter layer, a planarization layer, a dielectric layer, and a spacer layer to create a front panel of an LCD device. Each layer may be created using one or more than one iteration of the functions shown in blocks 202 through 208. In other embodiments, more or fewer layers may be generated and transferred to substrate 116.

In another embodiment of the method of FIG. 3, the optical layers generated and transferred to substrate 116 include a spacer layer that is applied over the electronics and any other layers (e.g., a planarization and/or passivation layer) of a rear panel of an LCD device.

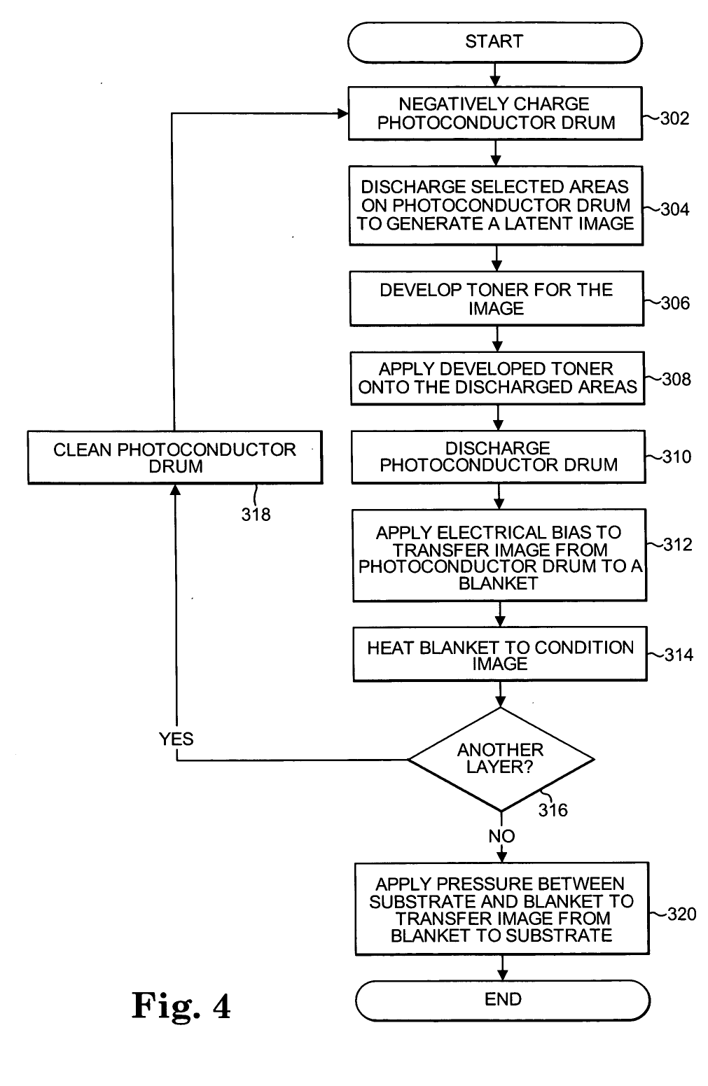

FIG. 4 is a flow chart illustrating a method for generating and transferring layers, including a spacer layer, to a substrate with a blanket using a liquid electrophotography process. The method of FIG. 4 will be described with reference to system 100.

In FIG. 4, charging system 104 negatively charges photoconductor drum 106 as indicated in a block 302. Imaging system 102 discharges selected areas on photoconductor drum 106 to generate a latent image on photoconductor drum 106 as indicated in a block 304. A liquid toner cartridge 108 is activated to develop toner for the image as indicated in a block 306. The activated liquid toner cartridge 108 applies developed toner to the discharged areas of photoconductor drum 106 to develop the latent image as indicated in a block 308. For the spacer layer, spacer liquid toner cartridge 108 is activated to apply liquid toner and spacer elements to the discharged areas of photoconductor drum 106 to develop the latent image. A discharging system (not shown) discharges photoconductor drum 106 as indicated in a block 310.

An electrical bias is applied to intermediate transfer member 110 to transfer the image from photoconductor drum 106 to blanket 112 as indicated in a block 312. Intermediate transfer member 110 heats blanket 112 to condition the image by causing the Isopar in the liquid toner to evaporate and the plastic-coated particles in the liquid toner to form a film as indicated in a block 314.

A determination is made as to whether there is another layer to generate as indicated in a block 316. If there is another layer to generate, then photoconductor drum 106 is cleaned to remove any remaining toner as indicated in a block 318 and the process of blocks 302 through 314 is repeated for the next layer. The next layer may be generated using liquid toner from the same or a different liquid toner cartridge 108 as the previous layer.

If there is not another layer to generate, then impression mechanism 114 applies pressure between substrate 116 and intermediate transfer member 110 to cause the combined image to be transferred from blanket 112 to substrate 116 as impression mechanism 114 drives substrate 116 between intermediate transfer member 110 and impression mechanism 114 as indicated in a block 320.

In one embodiment of the method of FIG. 4, the optical layers generated and transferred to substrate 116 include a black matrix layer, a color filter layer, a planarization layer, a dielectric layer, and a spacer layer to create a front panel of an LCD device. Each layer may be created using one or more than one iteration of the functions shown in blocks 302 through 314. In other embodiments, more or fewer layers may be generated and transferred to substrate 116.

In another embodiment of the method of FIG. 4, the optical layers generated and transferred to substrate 116 include a spacer layer that is applied over the electronics and any other layers (e.g., a planarization and/or passivation layer) of a rear panel of an LCD device.

FIG. 5 is a flow chart illustrating a method for generating and transferring optical layers of a display panel to substrate 116 using a liquid electrophotography process as described above with reference to the embodiments of FIGS. 2 and 3. In particular, each layer in the embodiment of FIG. 5 is created using either substantially the functions of blocks 202 through 208 of FIG. 3 or substantially the functions of blocks 302 through 314 and 318 of FIG. 4. The creation of each layer may involve one or more iterations of the functions of blocks 202 through 208 of FIG. 3 or the functions of blocks 302 through 314 and 318 of FIG. 4.

In FIG. 5, a dielectric layer is created on blanket 112 as indicated in a block 400. A planarization layer is created on blanket 112 as indicated in a block 402. Color filter layers are created on blanket 112 as indicated in a block 404. A black matrix layer is created on blanket 112 as indicated in a block 406. The layers, including the black matrix, color filter, planarization, and dielectric layers, are simultaneously transferred to substrate 116 as indicated in a block 408. A spacer layer is created on blanket 112 as indicated in a block 410. The spacer layer is transferred to substrate 116 as indicated in a block 412. Substrate 116 and the transferred layers, including the the black matrix, color filter, planarization, dielectric, and spacer layers, collectively comprise a front panel of an LCD device.

In other embodiments, the spacer layer may be combined with one or more other layers such as the black matrix layer or the planarization layer. In these embodiments, the liquid toner of the spacer liquid toner cartridge 108 may comprise a pigmented liquid toner (e.g., black liquid toner).

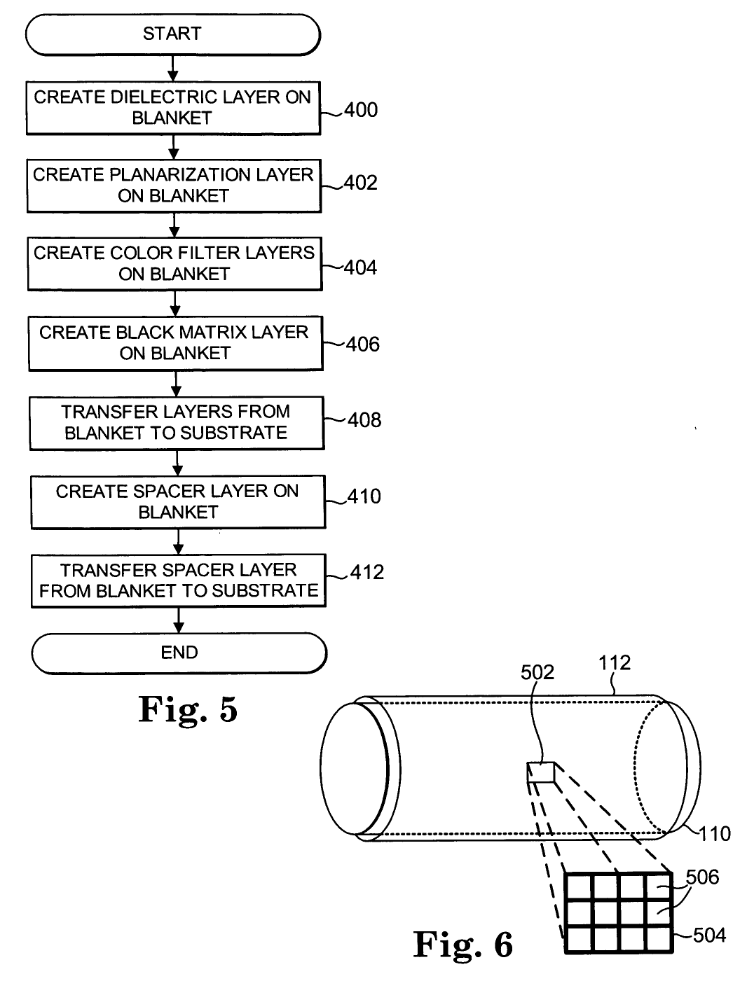

FIG. 6 is a schematic diagram illustrating layers transferred to blanket 112 as part of a liquid electrophotography process as described above with reference to the embodiments of FIGS. 1 through 4. As shown in a selected portion 502 of blanket 112, the layers created on blanket 112 include a black matrix layer 504 and color filter layers 506 interspersed in black matrix layer 504. The layers also include at least a planarization layer (not shown), a dielectric layer (not shown), and a spacer layer (not shown). Other embodiments include patterns of black matrix layer 504 other than the pattern shown in FIG. 6.

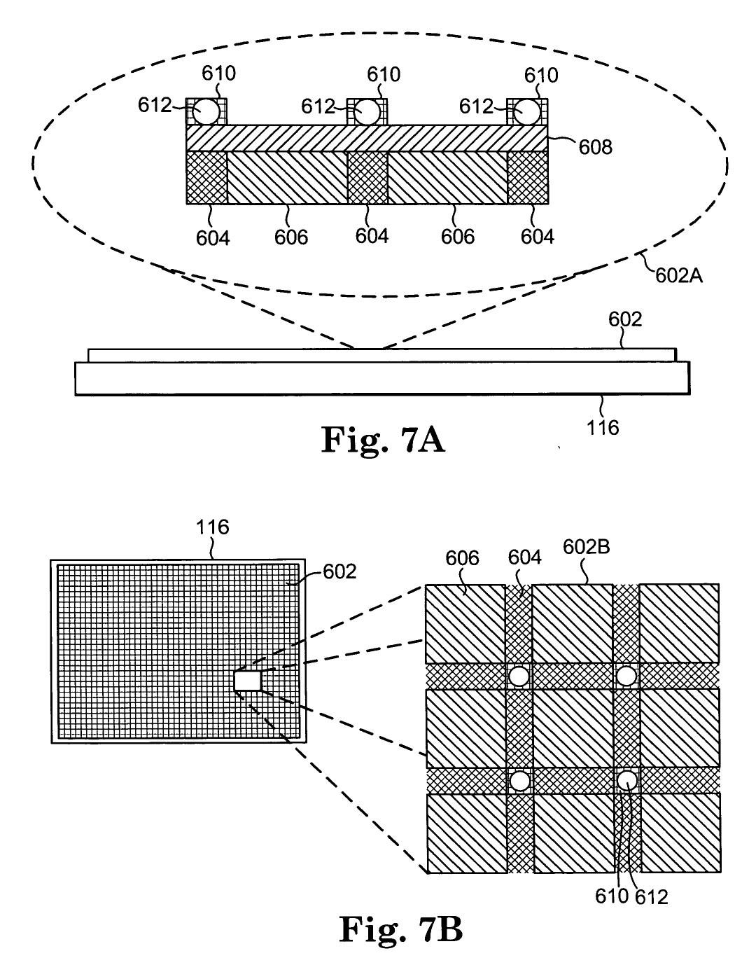

FIGS. 7A and 7B are schematic diagrams illustrating first and second perspectives of layers 602 transferred to substrate 116 using a liquid electrophotography process as described above with reference to the embodiments of FIGS. 1 through 4. In the embodiment of FIGS. 7A and 7B, substrate 116 comprises a front panel of an LCD device.

FIG. 7A illustrates a side view showing layers 602 on substrate 116. Additional details of a cross-section of one embodiment of layers 602 are shown in an expanded portion 602A. Layers 602 include a black matrix layer 604 interspersed between color filter layers 606. A planarization and dielectrics layer 608 is adjacent to black matrix layer 604 and color filter layers 606. Spacer layer 610 is adjacent to planarization and dielectrics layer 608 and aligns with black matrix layer 604 in this embodiment. Spacer layer 610 includes spacer elements 612.

FIG. 7B illustrates a top view showing layers 602 on substrate 116 where an expanded portion 602B shows color filter layers 606 interspersed in black matrix layer 604. In this embodiment, spacer layer 610 and spacer elements 612 align with intersection of the lines of black matrix layer 604. In other embodiments, spacer layer 610 and spacer elements 612 may align with other portions of black matrix layer 604.

In other embodiments, other patterns of black matrix layer 604 may be used, and spacer layer 610 and spacer elements 612 may or may not align with selected portions of black matrix layer 604.

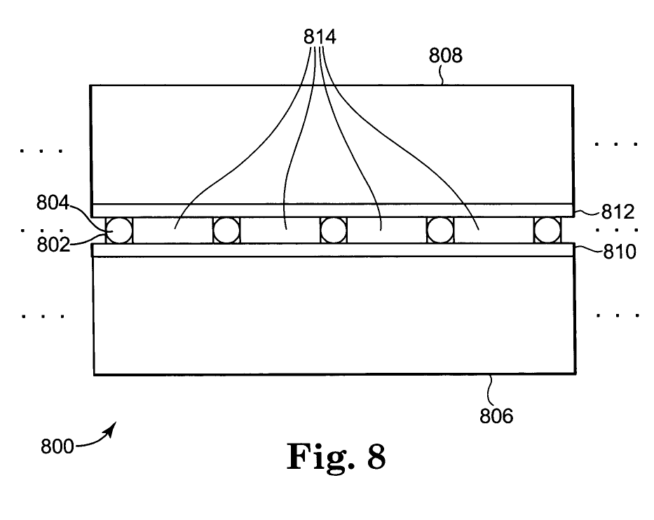

FIG. 8 is a schematic diagram illustrating a cross-section of a portion of a liquid crystal display (LCD) device 800. LCD device 800 includes a spacer layer 802 with spacer elements 804 that separates a front panel 806 and a rear panel 808. Front panel 806 includes a color filter 810 with black matrix, color filter, planarization, and dielectric layers. Rear panel 808 includes electronics layer 812 with a transistor or diode and conductive interconnect lines for each pixel formed in LCD device 800. Each transistor or diode is operated to cause an associated pixel in LCD device 800 to transmit or not transmit light according to an image to be displayed.

Liquid crystal material is inserted into spaces 814 formed between front panel 806 and rear panel 808 by spacer elements 804. In one embodiment, heat and/or pressure may be applied to front panel 806 and/or rear panel 808 to cause the toner in spacer layer 802 to migrate and allow the separation between front panel 806 and/or rear panel 808 to be set to approximately the diameter of spacer elements 804. For example, internal or external vacuum pressure may be applied to cause the toner in spacer layer 802 to migrate. The liquid crystal material may be inserted into spaces 814 prior or subsequent to the application of heat and/or pressure to front panel 806 and/or rear panel 808.

In other embodiments, spacer elements 804 may be applied in color filter 810 (e.g., in the black matrix layer) or electronics layer 812 such that spacer layer 802 is integrally formed with color filter 810 or electronics layer 812.

LCD device 800 comprises any type of LCD device such as a flat screen or rear projection television, a personal computer system display, a laptop or notebook computer system display, or a video or image display system, for example.

The use of the above embodiments may allow an optimal spacing and density of spacer elements in various applications including the spacing of the front and rear panels of an LCD device. With an LCD device, an optimal number and density of spacer elements may be used to achieve a desired panel surface point load and panel stiffness.

In addition, the location and placement of the spacer elements may be closely controlled. With an LCD device, the close control of the location and placement of the spacer elements allows the spacer elements to be placed outside of an optical path (e.g., outside of a pixel element) of the LCD device by aligning the spacer elements with the black matrix of the LCD device. By doing so, scatter and transmittance effects that may occur when spacer elements are located in the optical path may be eliminated.

Further, the liquid toner in the spacer layer may serve to bond the front and rear panels of a LCD device together. As a result, the structural and/or dimensional requirements of the panel edge bead of the LCD device may be reduced.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method comprising:
transferring first liquid toner having one or more spacer elements to a first discharged portion of the photoconductor drum to form a first image on the photoconductor drum; and
transferring the first image to a substrate.

2. The method of claim 1 further comprising:
transferring the first image from the photoconductor drum to an intermediate transfer member; and
transferring the first image from the intermediate transfer member to the substrate.

3. The method of claim 2 further comprising:
transferring second liquid toner to a second discharged portion of the photoconductor drum to form a second image on the photoconductor drum; and
transferring the second image to the substrate.

4. The method of claim 3 further comprising:
transferring the second image from the photoconductor drum to the intermediate transfer member prior to transferring the first image from the intermediate transfer member to the substrate.

5. The method of claim 1 further comprising:
charging the photoconductor drum; and
discharging a portion of the photoconductor drum to generate the first image.

6. The method of claim 1 wherein the substrate comprises a display panel.

7. A method comprising:
creating a spacer layer including a plurality of spacer elements on a blanket on an intermediate transfer member;
creating a color filter layer on the blanket on the intermediate transfer member; and
transferring the spacer layer and the color filter layer from the blanket to a substrate.

8. The method of claim 7 further comprising:
creating a black matrix layer on the blanket on the intermediate transfer member;
transferring the black matrix layer from the blanket to a substrate along with the spacer layer and the color filter layer.

9. The method of claim 7 wherein the spacer layer includes a black matrix layer.

10. The method of claim 7 further comprising:
creating the spacer layer using liquid toner and a plurality of spacer elements.

11. The method of claim 10 wherein the plurality of spacer elements comprise a plurality of glass spheres.

12. The method of claim 7 further comprising:
creating the spacer layer on a photoconductor drum;
creating the color filter layer on the photoconductor drum; and
transferring the spacer layer and the color filter layer from the photoconductor drum to the blanket.

13. A liquid crystal display device that includes a display panel generated by:
transferring liquid toner and a plurality of spacer elements to a first discharged portion of the photoconductor drum to form a first image on the photoconductor drum; and
transferring the first image to the display panel.

14. The liquid crystal display device of claim 13 generated by:
transferring the first image from the photoconductor drum to a intermediate transfer member; and
transferring the first image from the intermediate transfer member to the display panel.

15. The liquid crystal display device of claim 14 generated by:
transferring second liquid toner to a second discharged portion of the photoconductor drum to form a second image on the photoconductor drum; and
transferring the second image to the display panel.

16. The liquid crystal display device of claim 15 generated by:
transferring the second image from the photoconductor drum to the intermediate transfer member prior to transferring the first image from the intermediate transfer member to the substrate.

17. The liquid crystal display device of claim 13 generated by:
charging the photoconductor drum; and
discharging a portion of the photoconductor drum to generate the first image.

18. The liquid crystal display device of claim 13 wherein the display panel comprises a front panel of the liquid crystal display device.

19. The liquid crystal display device of claim 13 wherein the display panel comprises a rear panel of the liquid crystal display device.

20. An apparatus for applying a plurality of spacer elements, the apparatus comprising:
a photoconductor drum;
a first liquid toner cartridge configured to transfer first liquid toner and the plurality of spacer elements to a first discharged portion of the photoconductor drum to form a first image on the photoconductor drum;
an intermediate transfer member configured to receive the image from the photoconductor drum; and
an impression mechanism configured to drive a substrate along the intermediate transfer member to cause the first image to be transferred to the substrate.

21. The apparatus of claim 20 further comprising:
a charging system configured to charge the photoconductor drum; and
an imaging system configured to create the first discharged portion of the photoconductor drum.

22. The apparatus of claim 20 wherein the intermediate transfer member includes a blanket configured to receive the first image from the photoconductor drum.

23. The apparatus of claim 22 wherein the intermediate transfer member is configured to heat the blanket.

24. The apparatus of claim 20 wherein the plurality of spacer elements comprise a plurality of glass spheres.

25. The apparatus of claim 20 further comprising:
a second liquid toner cartridge configured to transfer second liquid toner to a second discharged portion of the photoconductor drum to form a second image on the photoconductor drum.

26. The apparatus of claim 25 wherein the second liquid toner cartridge configured to transfer the second liquid toner to the second discharged portion of the photoconductor drum to form the second image on the photoconductor drum prior to the first image being transferred to the display panel.

27. The apparatus of claim 20 wherein the impression mechanism is configured to apply pressure between the display panel and the intermediate transfer member to cause the image to be transferred to the display panel.

28. A method comprising:
a step for transferring liquid toner and one or more spacer elements to a first discharged portion of the photoconductor drum to form an image on the photoconductor drum; and
a step for transferring the image to a substrate.

29. The method of claim 28 further comprising:
a step for transferring the image from the photoconductor drum to an intermediate transfer member; and
a step for transferring the image from the intermediate transfer member to the substrate.

30. The method of claim 28 wherein the substrate comprises a display panel of an liquid crystal display device.
